(19) United States
(12) Patent Application Publication
(10) Pub. No.: US 2007/0233923 A1
(43) Pub. Date: Oct. 4, 2007

(54) Bus arbitration system and method thereof

(75) Inventor: Ki-Jong Lee, Yongin-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/710,980

(22) Filed: Feb. 27, 2007

(30) Foreign Application Priority Data
Feb. 28, 2006 (KR) 10-2006-0019033

(51) Int. Cl. G06F 13/36

(52) U.S. Cl. 710/116

(57) ABSTRACT

A bus arbitration system may include a plurality of masters and a bus arbiter. Each of the plurality of masters may include a buffer and/or a buffer level sensor to generate a control signal based on a length of a data queue in the buffer and a critical value of the length. The bus arbiter may arbitrate bus occupation between the plurality of masters according to original priorities, and may selectively modify the original priorities of a first master and a second master of the plurality of masters based on bus resource utilization. Therefore, a real-time bus environment may be reflected in arbitrating bus occupation.

### PRIORITY STATEMENT

This application claims priority under 35 USC § 119 to Korean Patent Application No. 2006-19033, filed on Feb. 28, 2006 in the Korean Intellectual Property Office (KIPO), the entire contents of which are incorporated herein by reference.

### BACKGROUND

1. Field

Example embodiments are directed to a bus system, for example, to a bus arbitration system and method capable of controlling bus occupation priority among bus masters.

2. Description of the Related Art

Generally, a bus may be used to transfer a control signal and/or data between functional blocks. A bus system may include a plurality of bus masters, a plurality of slaves, and/or a bus arbiter. The plurality of bus masters may use a bus to perform a write operation and/or a read operation with respect to the slaves. The functional blocks capable of requesting bus occupation may be referred to as a master (or a bus master), and functional blocks that may not be capable of requesting bus occupation may be referred to as slaves (or bus slaves). The bus master may transmit a request signal to the bus arbiter in order to occupy the bus. The bus arbiter may perform arbitration to select the desired bus master among the plurality of bus masters coupled to the bus, and then may grant occupation (or ownership) of the bus to the selected bus master.

The bus arbiter may output a grant signal, including information related to granting occupation of the bus, to the bus master having a higher priority by considering priorities assigned to the bus masters. The plurality of bus masters may perform a write operation and/or a read operation with respect to the slaves through the bus according to the grant signal.

Methods of assigning priorities to the bus masters may include a fixed-priority mode and/or a round-robin mode.

In the fixed-priority mode, when at least two bus masters request the occupation of the bus to the bus arbiter, the bus arbiter may output the grant signal to the bus master having the higher priority according to predetermined or desired priorities of the bus masters.

Thus, a bus master having a lower priority may not occupy the bus even though a data transmission amount may be increased suddenly, resulting in data loss and/or starvation. In other words, a data occupation rate of a buffer in the bus master may not be reflected in real time, and thus system performance may be degraded.

In the round-robin mode, the bus arbiter may equally assign a priority to each bus master according to pointer information. After a bus master receives the grant signal, a lower priority may be assigned to that bus master and a higher priority may be assigned to a next bus master according to a sequence of the pointer information.

Thus, although a bus master may need prompt occupation of the bus, the bus master may not promptly occupy the bus in the round-robin mode. For example, for a bus master of an image input device or a display device that may need to periodically transmit data, optimum bus arbitration may not be achieved in the fixed-priority mode or in the round-robin mode.

### SUMMARY

According to example embodiments, a bus arbitration system may include multiple bus masters and a bus arbiter, configured to selectively modify the priorities of the bus masters based on buffer resource utilization. Each of the masters may include a buffer and a buffer level sensor. Each buffer level sensor may generate a control signal based on a length of a data queue in the buffer and a critical value of the length. The bus arbiter may arbitrate bus occupation among the masters according to original priorities, and may selectively modify the original priorities of a first master and a second master of the plurality of masters based on a first control signal received from the first master and a second control signal received from the second master.

A first critical value of the first master may correspond to a data amount sufficient to cause a data underflow in the buffer of the first master, and the first master may activate the first control signal when the length of the data queue in the buffer of the first master is not less than the first critical value. A second critical value of the second master may correspond to a data amount sufficient to cause a data overflow in the buffer of the second master, and the second master may activate the second control signal when the length of the data queue in the buffer of the second master is not less than the second critical value. The bus arbiter may modify the original priorities of the first master and the second master so that the second master may have the bus occupation prior to the first master when both the first control signal and the second control signal are activated. The first and second critical values may be modifiable by a user.

The first and second masters may be included in a first group, and the original priority in the first group may be determined in a fixed-priority mode. In addition, each master not included in the first group may be included in a second group, and the original priority in the second group may be determined in a round-robin mode.

The first master may be a camera interface or a display device. The second master may be a codec or an image converter.

According to example embodiments, a bus arbitration system may include a first bus master, a second bus master and a bus arbiter. The first master may detect a first length of a data queue in a buffer of the first master in order to generate a flag signal when the first length is not less than a first critical value. The second master may provide length information of a data queue in a buffer of the second master in response to the flag signal, in which the second master may have a higher priority for occupying a bus than the first master. The bus arbiter may selectively modify the priority of the first and second masters based on the length information.

The second master may have the highest priority among all masters coupled to the bus. The length information may include whether a second length of the data queue in a buffer of the second master is not less than a second critical value. The second critical value may be determined based on a data amount sufficient to cause a data underflow in the buffer of the second master. The first critical value may be determined based on a data amount sufficient to cause a data overflow in the buffer of the first master. The first and second critical values may be modifiable by a user. When the second length is not less than the second critical value, the priority of the first bus master may be modified so that the first master may occupy the bus prior to the second master. The second master may be a camera interface or a display device, and the first master may be a codec or an image converter.

A bus arbitration system according to example embodiments may include a plurality of masters, each having a corresponding priority, where a fixed priority mode may be applied to certain masters and a round robin priority mode may be applied to other masters. The fixed priority mode may be applied to masters whose priorities are different from each other and the round robin priority mode may be applied to masters whose priority is the same. An arbiter may be configured to selectively modify the priorities of the plurality of masters based on the resource utilization of buffers in each of the plurality of masters.

A method of bus arbitration according to example embodiments may include arbitrating bus occupation among at least two masters, according to the priority of each master, and selectively modifying the priorities a first master and a second master based on buffer resource utilization. The method may further include generating a control signal for each master based on a length of a data queue in the corresponding buffer and a critical value of the length, arbitrating bus occupation among the masters according to original priorities, and selectively modifying the priorities of the first master and the second master based on a first control signal received from the first master and a second control signal received from the second master.

A method of bus arbitration may also include detecting a first length of a data queue in a buffer of a first master in order to generate a flag signal when the first length is not less than a first critical value, providing length information of a data queue in a buffer of a second master in response to the flag signal, in which the second master may have a higher priority for occupying a bus than the first master, and selectively modifying the priority of the first and second masters based on the length information.

The second master may have the highest priority among all masters coupled to the bus. The first critical value may be determined based on a data amount sufficient to cause a data overflow in the buffer of the first master. The length information may include whether a second length of the data queue in the buffer of the second bus master is not less than a second critical value. The second critical value may be determined based on a data amount sufficient to cause a data underflow in the buffer of the second master. When the second length is not less than the second critical value, the priority of the first master may be modified so that the first master may occupy the bus prior to the second master.

### BRIEF DESCRIPTION OF THE DRAWINGS

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a block diagram illustrating an example bus arbitration system according to example embodiments.

FIG. 2 is a block diagram illustrating an example configuration of each bus master in the bus arbitration system of FIG. 1.

FIG. 3 is a block diagram illustrating an example bus arbitration system according to example embodiments.

FIG. 4 is a flow chart illustrating a method of bus arbitration according example embodiments.

FIG. 5 is a flow chart illustrating a method of bus arbitration according to example embodiments.

### DESCRIPTION OF EXAMPLE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

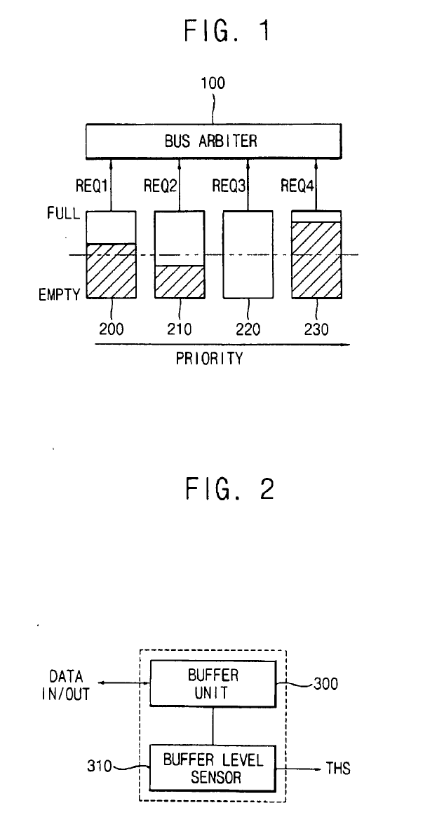

FIG. 1 is a block diagram illustrating a bus arbitration system according example embodiments.

Referring to FIG. 1, the bus arbitration system may include a bus arbiter 100 and a plurality of bus masters 200, 210, 220 and 230. In the case of a digital image system, for example, the bus masters 200, 210, 220 and 230 may correspond to a central processing unit (CPU), a JPEG/MPEG codec, a display device, a camera interface, etc . . . The plurality of bus masters 200, 210, 220 and 230 may respectively output request signals REQ1, REQ2, REQ3 and REQ4 including information related to a request for use of the bus to transmit data to and/or receive data from a slave (for example, a memory controller) through the bus.

The plurality of bus masters 200, 210, 220 and 230 may have corresponding priorities so that a fixed priority mode may be applied to the bus masters whose priorities may be different from each other, and a round-robin mode may be applied to the bus masters whose priorities may be the same. In addition, a programmable fixed priority capable of flexibly programming priorities of the bus masters may be applied. The priority of each bus master may be determined according to, for example, access frequency of an external memory.

When the bus master corresponds to, for example, a camera interface that may receive an image signal and output digital image data, or a display device that may provide an image to a user, the bus master may request ownership (or occupation) of the bus periodically to output data by accessing shared memory. The example camera interface or display device may operate according to a sync signal determining a frame unit, and may increase bus access usage. Thus, the example camera interface or display device may be assigned a higher priority based on bus access usage. In addition, when the bus master corresponds to, for example, an image codec that may perform image data processing, the bus access usage may be less than that of the example camera interface or display device and the image codec may be assigned a lower priority. When the bus system in FIG. 1 is applied to a digital image system, for example, a functional block that may access external memory in order to periodically transmit data may be included in the digital image system, and the fixed priority mode may be applied.

According to example embodiments, the relative priorities of the bus masters 200, 210, 220 and 230 may decrease according to an arrangement order. For example, the first bus master 200 may have the highest priority and the fourth bus master 230 may have the lowest priority.

When request signals of more than two bus masters are activated, the bus arbiter 100 may grant ownership of the bus to the bus master having the higher priority. The bus arbiter 100 may determine the priority of the bus masters that transmit the request signals by using a priority register in which priority information may be stored. For example, in the fixed priority mode, a register may store a fixed priority, and in the round-robin mode, the bus arbiter may modify the priority information stored in the priority register so that the bus master corresponding to the pointer information may have the higher priority. The pointer information may be periodically modified, for example, when a grant signal is output.

The plurality of bus masters 200, 210, 220 and 230 may include a buffer to store data. The buffer may be implemented, for example, according to a first-in-first-out (FIFO) mode. Thus, the buffer may receive data from an input port of the bus master in order to manage and read the data according to an input order, and may transmit the data to an output port of the bus master.

If the fixed priority mode is applied to the bus system in FIG. 1, the bus arbiter 100 may receive request signals from the plurality of bus masters 200, 210, 220 and 230 and may grant ownership of the bus to the first bus master 200 having the highest priority. Data occupation rates of buffers in the second, third and fourth bus masters 210, 220 and 230 may be checked according to the bus arbitration system. When the data occupation rate of a buffer in a bus master is higher than a predetermined or given value, the bus arbiter 100 may selectively modify the priority so that the bus master in which the data occupation rate is higher than the predetermined or given value may promptly use the bus. The bus master whose priority is modified may receive the grant signal to write data stored in the buffer to the external memory via a slave, for example, the memory controller, through the bus. The data occupation rate of each buffer may be checked by referring to a pointer value including information related to current data occupation rates of the buffers.

If the buffer in, for example, the fourth bus master 230 stores more data than a predetermined or given amount, the available storage capacity may be insufficient. Thus, if the fourth bus master 230 does not occupy the bus, the buffer in the fourth bus master 230 may be ‘full’ and input data may be lost. In this case, the priority may be modified to prevent a data overflow of the buffer in the fourth bus master 230. The priority of the fourth bus master 230 may be modified to the highest priority so that the fourth bus master 230 may be granted ownership of the bus. After the fourth bus master 230 has sufficiently occupied the bus, the priority of the fourth bus master 230 may be returned to the original priority according to the fixed priority mode.

The priority may be modified by controlling the pointer information to point to a register corresponding to the bus master that may have the highest priority. For example, the pointer information may correspond to two-bit signals; that is, the signals ‘00’, ‘01’, ‘10’ and ‘11’ may correspond to the first, second, third and fourth bus masters 200, 210, 220 and 230, respectively. The pointer information may be fixed to constant values in the case of fixed priority, and may be applied from outside the system.

If the first bus master 200 having the highest priority occupies the bus later, the priority of the fourth bus master 230 may be selectively modified. Thus, if a data underflow results in a case where the first bus master does not occupy the bus, the priority of the fourth bus master 230 may not be modified and the first bus master 200 may occupy the bus.

For example, in the case of an image processing system, the bus arbiter 100 may grant the highest priority to a bus master which transmits a read request signal for reading image data by accessing the external memory and a lower priority to a bus master which transmits a write request signal for writing the image data by accessing the memory. In the case that the first bus master corresponds to an image input device such as a camera interface, the camera interface may perform a read operation for reading decoded image data stored in the memory by accessing the external memory through the bus. The read data may, for example, be stored in a buffer in the camera interface and may be transmitted to a format converter, etc . . . , to be converted into a predetermined or given format. In the case that the first bus master corresponds to a display device, the display device may perform a read operation for reading image data according to frame units by accessing the external memory through the bus to display the image data. When the bus master periodically performs a read operation, a data underflow may be caused by insufficient output data due to an occupation rate of a buffer lower than a predetermined or given value.

In the case that the third bus master 220, for example, has the highest priority, the data occupation rates of the buffers in the third and fourth bus masters 220 and 230 may be respectively checked according to example embodiments. The data occupation rate of the third bus master 220 may be ‘empty’ so that output data may be insufficient and a data underflow may result in the case of a display device, for example, a liquid crystal display device that outputs periodically. Thus, although the data occupation rate of the buffer in the fourth bus master 230 may be higher than a predetermined or given value, the priority may not be modified and the third bus master 220 may be granted the grant signal and may use the bus.

FIG. 2 is a block diagram illustrating a configuration of a bus master in the bus arbitration system of FIG. 1. FIG. 2 illustrates only a brief configuration for the sake of explanation.

Referring to FIG. 2, the bus master may include a buffer unit 300 and a buffer level sensor 310. The buffer unit 300 may include a work queue, for example, a data queue to temporarily store data read/written from/to the bus master. The buffer level sensor 310 may detect a length of the data queue of the buffer unit 300 according to pointer information transmitted from the buffer unit 300 and may determine whether the length of the data queue of the buffer unit 300 is larger than a predetermined or given critical value.

When the length of the data queue of the buffer unit 300 is larger than the critical value, the buffer level sensor 310 may provide a control signal THS to the bus arbiter.

In the case that a data occupation rate of a buffer in the bus master having a lower priority is higher than a critical value, and if the bus master having the lower priority does not use the bus to write data into an external memory, input data may be continuously lost and a data overflow may result. Thus, the critical value may be based on a length of a data queue sufficient to cause a data overflow.

In this case, whether the bus master having the lower priority may occupy the bus may be determined according to the length of the data queue of the buffer in the bus master having the highest priority.

The buffer level sensor 310 of the bus master having the highest priority may determine whether the length of the data queue of the buffer is larger than the predetermined or given critical value. The critical value of the bus master having the highest priority may indicate the possibility that a data underflow may result in the bus master having the highest priority. When the length of the data queue of the buffer in the bus master having the highest priority is less than the critical value, (for example, when the data occupation rate of the buffer is sufficiently low) a data underflow may result in a case where the bus master with the lower priority may not use the bus. When the length of the data queue of the buffer in the bus master having the highest priority is larger than the critical value, (for example, when the data occupation rate of the buffer is sufficiently high) the bus master may output data stored in the buffer for some frames in a case where the bus master does not use the bus and does not receive data from the external memory. In other words, the priority may be modified so that the bus master having the lower priority may be assigned ownership of the bus.

When the length of the data queue of the buffer in the bus master having the highest priority is determined to meet the predetermined or given critical value, the bus master having the highest priority may generate the control signal THS.

Control signals THS, respectively generated from the bus master having the highest priority and the bus master having the lower priority, may be provided to the bus arbiter and the bus arbiter may grant ownership of the bus to the bus master having the lower priority.

Buffer sizes of the bus masters may be different from each other according to bus access frequency, data processing amount, etc . . . , and critical values may be determined based on the buffer sizes. In addition, the critical values may be modified by a user to provide optimum conditions for use of the bus.

In example embodiments, the bus master may further include a timer (not shown). The timer may measure the time from when the bus master transmits a request signal until the bus master is granted access to the bus. In example embodiments, when the bus master does not receive a grant signal after a predetermined or given time, an interrupt signal may be generated, or the priority may be modified and the bus master may be granted ownership of the bus.

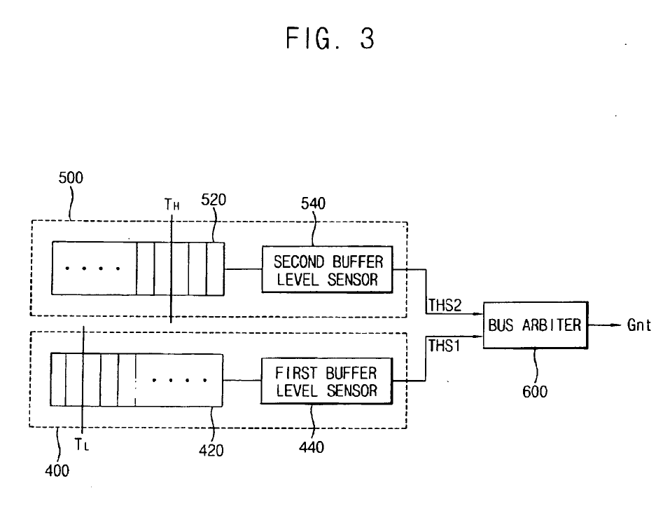

FIG. 3 is a block diagram illustrating a bus arbitration system according to example embodiments.

Referring to FIG. 3, the bus arbitration system may include a first bus master 400 having the highest priority, a second bus master 500 having a lower priority with respect to the first bus master 400, and a bus arbiter 600. The first bus master 400 may include a first buffer 420 and a first buffer level sensor 440. The second bus master 500 may include a second buffer 520 and a second buffer level sensor 540. The first and second buffers 420 and 520 may temporarily store data.

The first and second buffer level sensors 440 and 540 may detect lengths of data queues of the first and second buffers 420 and 520, respectively, to generate first and second control signals THS1 and THS2, respectively, when the lengths of the data queues are larger than a predetermined or given critical value. The first buffer level sensor 440 may determine whether the length of the data queue of the first buffer 420 is larger than a first critical value TL, and may generate the first control signal THS1 when pointer information including the data queue of the first buffer 420 is larger than the first critical value TL. The second buffer level sensor 540 may determine whether the length of the data queue of the second buffer 520 is larger than a second critical value TH, and may generate the second control signal THS2 when pointer information including the data queue of the second buffer 520 is larger than the second critical value TH.

For example, the first bus master 400 may correspond to a camera interface and the second bus master 500 may correspond to a codec. The first critical value TL may be fixed at about 25% of the buffer size of the camera interface and the second critical value TH may be fixed at about 75% of the buffer size of the codec. The first critical value TL may be determined by considering a case in which the first bus master 400 may be granted the grant signal and whether problems such as an underrun may or may not occur in the first buffer 420. The second critical value TH may be determined by considering a case in which the second bus master 500 promptly needs ownership of the bus but may not be granted ownership of the bus and whether a data overflow may result in the second buffer 520.

However, it should be understood that the foregoing is illustrated merely as an example, and a data occupation rate of the buffer for determining the critical value of each bus master may be changed according to bus access frequency, data processing amount, etc . . . In addition, the critical value may be modified by a user to provide optimum conditions for use of the bus.

When the data occupation rate of the buffer 520 is higher than the second critical value TH, a data overflow may result in the second buffer 520. When the data occupation rate of the buffer 420 is higher than the first critical value TL, although the first bus master 400 may not occupy the bus and may not receive data from an external memory, sufficient data may occupy the first buffer 420 to provide data to other functional blocks.

When the first and second control signals THS1 and THS2 are generated, the second bus master 500 may require ownership of the bus promptly in comparison with the first bus master 400, and the second bus master 500 may be granted the ownership of the bus. The bus arbiter 600 may grant the highest priority to the second bus master 500 based on the first and second control signals THS1 and THS2. In other words, the bus arbiter 600 may output a grant signal Gnt, including information related to granting usage of the bus, to the second bus master 500. After the second bus master 500 occupies the bus, the priority of the second bus master 500 may return to an original priority.

The second bus master 500 may be selected among a plurality of bus masters, wherein the priority of the second bus master 500 may be selectively modified, according to example embodiments. The bus master may be one of a plurality of functional blocks integrated on a system-on-chip (SOC). For example, in the case of an image system, priorities of a codec, an image converter, etc., of which variable input data amounts may cause buffers to become full, may be selectively modified.

Thus, the priorities of the bus masters may be modified based on resource utilization of the buffers. That is, as the data occupancy of a buffer in a corresponding bus master grows or shrinks, that corresponding bus master's need for prompt occupation of the bus may change, and the bus arbitration system and method according to example embodiments may selectively modify the priorities of the appropriate bus masters accordingly.

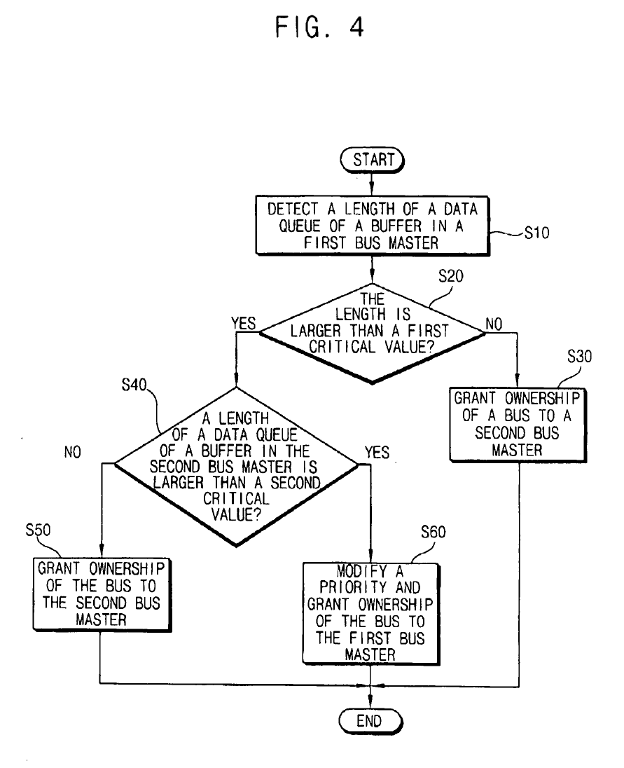

FIG. 4 is a flow chart illustrating a method of bus arbitration according example embodiments.

Referring to FIG. 4, a length Q1 of a data queue of a buffer in a first bus master may be detected (step S10) and it may be determined whether the length Q1 is larger than a first critical value T1 (step S20). A priority of the first bus master may be modifiable according to example embodiments.

In the case that the length Q1 is larger than the first critical value T1, data of the first bus master may be lost if the first bus master does not occupy the bus. Thus, it may be determined whether a length Q2 of a data queue of a buffer in a second bus master having the highest priority is larger than a second critical value T2 (step S40).

In the case that the length Q2 is larger than the second critical value T2, a data underflow may not result in the second bus master and the first bus master, which may require prompt ownership of the bus, may be assigned ownership of the bus. The priority of the first bus master may be selectively modified to have the highest priority so that the first bus master may occupy the bus (step S60).

In the case that the length Q2 is less than the second critical value T2, a data underflow may result in the second bus master if it does not occupy the bus. Thus, the priority of the first bus master may not be modified, and the second bus master having the highest priority may be assigned ownership of the bus (step S50).

In the case that the length Q1 is less than the first critical value T1, the first bus master may not promptly need ownership of the bus and the second bus master, having the highest priority, may be assigned ownership of the bus. The second bus master may be selected from among a plurality of bus masters transmitting a request signal by a fixed priority mode, a round-robin mode, etc . . . (step S30).

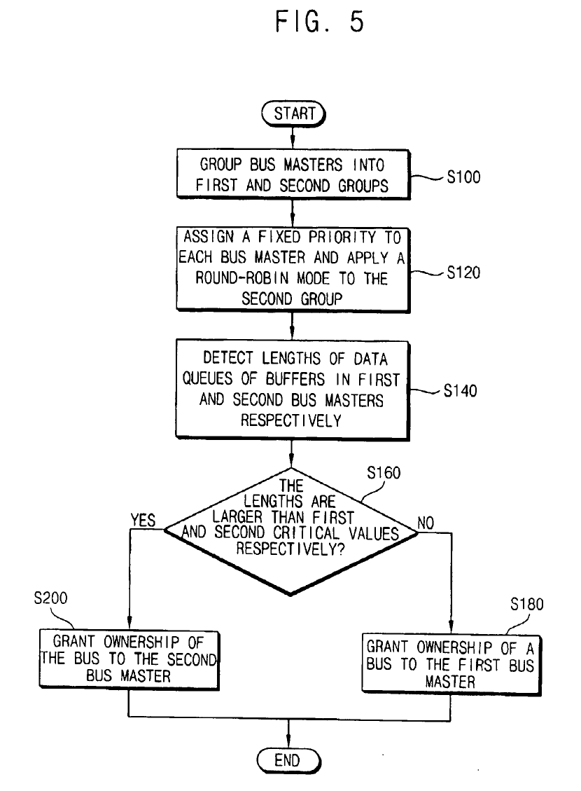

FIG. 5 is a flow chart illustrating a method of bus arbitration according to example embodiments.

FIG. 5 illustrates a case in which there are at least two bus masters. When a data occupation rate of a buffer in a bus master is higher than a critical value, bus masters, whose priorities are selectively modifiable so as to occupy a bus ahead of a bus master having the highest priority, may number more than two.

Referring to FIG. 5, a plurality of bus masters coupled to one bus may be grouped into a first group, in which priority may be modified according to a conventional priority mode, and a second group, in which priority may be selectively modified according to example embodiments (step S100). In the case of a digital image system, each bus master may be assigned ownership of the bus according to a fixed priority (for efficient operation of the system, for example), and bus masters included in the second group may be assigned ownership of the bus according to a round-robin mode (step S120).

For example, in a bus system including first through fifth bus masters M1, M2, M3, M4 and M5, the first through fifth bus masters M1, M2, M3, M4 and M5 may be respectively assigned first through fifth priorities in order, and the priorities of the second through fourth bus masters M2, M3 and M4 may be selectively modifiable. In this case, a bus arbitration order may correspond to M1->M2->M3->M4->M5->, M1->M3->M4->M2->M5->, M1->M4->M2->M3->M5, etc . . .

A length Q1 of a data queue of a buffer in the first bus master M1 having the highest priority and a length Q2 of a data queue of a buffer in one bus master, for example, the second bus master M2, which is assigned the highest priority among the second, third and fourth bus masters M2, M3 and M4 by a round-robin mode, may be checked (step S140).

It may be determined whether the length Q1 is larger than a first critical value T1 and whether the length Q2 is larger than a second critical value T2 (step S160). In the case that the lengths Q1 and Q2 are both larger than the first and second critical values T1 and T2, respectively, the second bus master M2 may need ownership of the bus promptly and the first bus master M1 may be granted ownership of the bus later so that the second bus master M2 may be granted ownership of the bus promptly (step S200). In the case that at least one of the lengths Q1 and Q2 is less than the first and second critical values T1 and T2, the priority may not be modified and the first bus master M1 having the highest priority may be granted ownership of the bus (step S180).

Example embodiments may be stored in a computer-readable recording media, for example, as computer-readable code. The computer-readable recording media may include multiple kinds of recording devices that may store computer-readable data, for example, ROM, RAM, CD-ROM, magnetic tape, diskette, optical and other types of data recording devices.

As mentioned above, the bus arbitration system and method according to example embodiments may modify a fixed priority mode applied among a plurality of bus masters. Data occupation rates of a bus master having the highest priority and a bus master having a lower priority may be checked, and priority may be selectively modified when the data occupation rates are higher than critical values, thereby providing that the bus master having the lower priority may occupy a bus. In this manner, a bus environment may be reflected in real time to arbitrate ownership of the bus and system performance may be improved.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A bus arbitration system, comprising:
at least two masters, each including a buffer and having a corresponding priority; and
a bus arbiter, configured to selectively modify the priorities of a first master and a second master of the at least two masters based on buffer resource utilization.

2. The bus arbitration system of claim 1, wherein each of the at least two masters further includes a buffer level sensor configured to generate a corresponding control signal based on a length of a data queue in the corresponding buffer and a critical value of the length; and
the bus arbiter is further configured to arbitrate bus occupation among the at least two masters according to original priorities, and selectively modify the priorities of the first master and the second master based on a first control signal received from the first master and a second control signal received from the second master.

3. The bus arbitration system of claim 2, wherein a first critical value of the first master corresponds to a data amount sufficient to cause a data underflow in the buffer of the first master, and the first master is configured to activate the first control signal when the length of the data queue in the buffer of the first master is not less than the first critical value.

4. The bus arbitration system of claim 3, wherein a second critical value of the second master corresponds to a data amount sufficient to cause a data overflow in the buffer of the second master, and the second master is configured to activate the second control signal when the length of the data queue in the buffer of the second master is not less than the second critical value.

5. The bus arbitration system of claim 4, wherein the bus arbiter modifies the original priorities of the first master and the second master so that the second master occupies the bus prior to the first master when both the first control signal and the second control signal are activated.

6. The bus arbitration system of claim 4, wherein the first and second critical values are modifiable by a user.

7. The bus arbitration system of claim 2, wherein the first and second masters are included in a first group, the original priority in the first group being determined in a fixed-priority mode.

8. The bus arbitration system of claim 7, wherein each master not included in the first group is included in a second group, the original priority in the second group being determined in a round-robin mode.

9. The bus arbitration system of claim 2, wherein the first master is a camera interface or a display device.

10. The bus arbitration system of claim 2, wherein the second master is a codec or an image converter.

11. The bus arbitration system of claim 1, wherein the first master is configured to detect a first length of a data queue in a buffer of the first master in order to generate a flag signal when the first length is not less than a first critical value;
the second master is configured to provide length information of a data queue in a buffer of the second master in response to the flag signal, the second master having a higher priority for occupying a bus than the first master; and
the bus arbiter is configured to selectively modify the priorities of the first and second masters based on the length information.

12. The bus arbitration system of claim 11, wherein the second master has the highest priority among all masters coupled to the bus.

13. The bus arbitration system of claim 11, wherein the length information includes whether a second length of the data queue in the buffer of the second master is not less than a second critical value.

14. The bus arbitration system of claim 13, wherein the second critical value is determined based on a data amount sufficient to cause a data underflow in the buffer of the second master.

15. The bus arbitration system of claim 14, wherein when the second length is not less than the second critical value, the priority of the first master is modified so that the first master occupies the bus prior to the second master.

16. The bus arbitration system of claim 13, wherein the first critical value is determined based on a data amount sufficient to cause a data overflow in the buffer of the first master.

17. The bus arbitration system of claim 16, wherein the first and second critical values are modifiable by a user.

18. The bus arbitration system of claim 11, wherein the second master is a camera interface or a display device.

19. The bus arbitration system of claim 11, wherein the first master is a codec or an image converter.

20. A bus arbitration system, comprising:
a plurality of masters, each having a corresponding priority, wherein a fixed priority mode is applied to at least two of the plurality of masters and a round robin priority mode is applied to at least two of the plurality of masters; and
an arbiter, configured to selectively modify the priorities of the plurality of masters.

21. The bus arbitration system of claim 20, wherein the fixed priority mode is applied to masters whose priorities are different from each other and the round robin priority mode is applied to masters whose priority is the same.

22. The bus arbitration system of claim 20, wherein the bus arbiter is configured to selectively modify the priorities of the plurality of masters based on the resource utilization of buffers in each of the plurality of masters.

23. A method of bus arbitration, comprising:
arbitrating bus occupation among at least two masters, each including a buffer and a corresponding priority, according to the priority of each master; and
selectively modifying the priorities a first master and a second master of the at least two masters based on buffer resource utilization.

24. The method of claim 23, further comprising:
generating a control signal for each master based on a length of a data queue in the corresponding buffer and a critical value of the length;
arbitrating bus occupation among the at least two masters according to original priorities; and
selectively modifying the priorities of the first master and the second master based on a first control signal received from the first master and a second control signal received from the second master.

25. The method of claim 23, comprising:
detecting a first length of a data queue in the buffer of the first master in order to generate a flag signal when the first length is not less than a first critical value;
providing length information of a data queue in the buffer of the second master in response to the flag signal, the second master having a higher priority for occupying a bus than the first master; and
selectively modifying the priority of the first and second masters based on the length information.

26. The method of claim 23, wherein the second master has the highest priority among all masters coupled to the bus.

27. The method of claim 23, wherein the first critical value is determined based on a data amount sufficient to cause a data overflow in the buffer of the first master.

28. The method of claim 23, wherein the length information includes whether a second length of the data queue in the buffer of the second master is not less than a second critical value.

29. The method of claim 28, wherein the second critical value is determined based on a data amount sufficient to cause a data underflow in the buffer of the second master.

30. The method of claim 28, wherein when the second length is not less than the second critical value, the priority of the first master is modified so that the first master occupies the bus prior to the second master.
